(19) United States
(12) Patent Application Publication
(10) Pub. No.: US 2007/0138969 A1
(43) Pub. Date: Jun. 21, 2007

(54) Circuit arrangement

(75) Inventors: John Evarist Karel Georges De Clercq, Nazareth Eke (BE); Hans Antoine Feijen, Oss (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/555,052

(22) PCT Filed: Apr. 29, 2004
(86) PCT No.: PCT/IB04/50547

§ 371 Date: Oct. 28, 2005

(30) Foreign Application Priority Data
May 2, 2003 (EP) 03101231.3

(51) Int. Cl. H05B 39/04

(52) U.S. Cl. 315/209 R

(57) ABSTRACT

In a ballast circuit for operating a discharge lamp, the discharge lamp is ignited by means of resonance. During ignition the lamp voltage is measured and compared with a reference value by a lamp voltage measurement circuit. The operation of the circuit arrangement is adapted in dependency of the outcome of the measurement. Before ignition of the lamp the proper functioning of the lamp voltage measurement circuit is tested. Ignition is only attempted when the lamp voltage measuring circuit is functioning correctly.

The invention relates to a circuit arrangement for igniting and operating a discharge lamp, equipped with
input terminals for connection to a supply voltage source,
an inverter coupled to the input terminals for generating a high frequency voltage out the supply voltage, and equipped with switching means and a control circuit for controlling the conductive state of the switching means,

a load circuit coupled between output terminals of the inverter and comprising lamp connection terminals arranged in series with an inductive element and shunted by a capacitive element,
a lamp voltage measuring circuit comprising
   a circuit part I for generating a first signal that represents the voltage across the discharge lamp,
   a circuit part II for generating a second signal representing a desired value of the lamp voltage,
   a comparator equipped with a first input terminal coupled to an output terminal of circuit part I, and with a second input terminal coupled to an output terminal of circuit part II,
a circuit part III for changing the operating state of the circuit arrangement and coupled to an output terminal of the comparator.

The invention also relates to a projection equipment comprising a high pressure discharge lamp and such a circuit arrangement.

Such a circuit arrangement is generally known.

In the known circuit arrangement the discharge lamp is ignited by adjusting the frequency of the high frequency voltage that is generated by the inverter at a value that is close to the resonance frequency of the inductive element and the capacitive element comprised in the load circuit. At this frequency the amplitude of the voltage across the discharge lamp is comparatively high so that this voltage will ignite the discharge lamp. However, at a frequency close to resonance there is the possibility that the inductive element will partly saturate. This saturation will cause the resonance frequency to increase and will therefor also cause the amplitude of the lamp voltage to increase. This increase of the lamp voltage in turn can lead to a further saturation of the inductive element so that the lamp voltage increases even further etc. This increase in the lamp voltage can cause un safe voltages over the inductive element and the capacitive element comprised in the load circuit, but also at the lamp connector, the lampwires, the lamp housing and the lamp socket. Additionally, a very high lamp voltage during ignition can do damage to both circuit components as well as to the discharge lamp itself. For these reasons it is necessary to measure the lamp voltage and control it. This is done by the lamp voltage measuring circuit. The first circuit part I generates a first signal representing the lamp voltage. The comparator is used to compare the first signal with a second signal generated by the second circuit part II and representing a desired value of the lamp voltage. When the first signal exceeds the second signal, circuit part III changes the operating state of the circuit arrangement. Circuit part III can for instance terminate the control of the switching means comprised in the inverter so that the inverter no longer generates the high frequency voltage. Alternatively the lamp voltage measuring circuit could be part of a lamp voltage control loop in which the circuit part III via the control circuit adjusts the frequency of the high frequency voltage at a somewhat higher value so that the lamp voltage is somewhat decreased. Irrespective of the precise nature of the circuit part III, it is essential that the lamp voltage measuring circuit is functioning properly. In case for instance the value of the first signal is too low because of a bad contact in the circuit part I, the voltage across the lamp would reach values far higher than the desired value, causing damage to the lamp, the circuit arrangement or both and causing an unsafe operating condition for the user.

It is an object of the invention to prevent unsafe operating conditions and damage to the circuit arrangement and/or the discharge lamp caused by malfunctioning of the lamp voltage measuring circuit.

A circuit arrangement as mentioned in the opening paragraph is therefore characterized in that the circuit arrangement is further equipped with
a start circuit coupled to the control circuit for maintaining the circuit arrangement in a first operating state in which the actual lamp voltage is smaller than the desired value,
a test circuit, comprised in the lamp voltage measuring circuit, for making the first signal larger than the second signal during the first operating state.

The operating conditions in the first operating state are chosen such that damage to the discharge lamp or the circuit arrangement due to a high lamp voltage is avoided. The first operating state can for instance be realized by maintaining the frequency at which the control circuit controls the switching means comprised in the inverter at a comparatively high value so that the lamp voltage is comparatively low. In spite of the comparatively low value of the lamp voltage, the test circuit makes sure that the first signal is larger than the second signal so that the voltage present at the output terminal of the comparator changes, in case the lamp voltage measuring circuit is functioning correctly. In case the voltage at the output terminal actually changes, the first operating state is abandoned and the control circuit controls the switching means comprised in the inverter at such a frequency that the amplitude of the voltage across the discharge lamp is increased, so that the lamp is ignited. This can be done by maintaining the frequency at which the switching means in the inverter are controlled at a value close to the resonance frequency of the load circuit until the discharge lamp ignites. Alternatively, the frequency at which the switching means in the inverter are controlled can be swept a number of times from a high value to a value close to the resonance frequency until the lamp ignites. In case the voltage at the output of the comparator does not change during the first operating state, this indicates that the lamp voltage measuring circuit is not functioning correctly. The circuit part III ensures that no attempts are made to ignite the discharge lamp. The circuit part III can for instance be coupled to the control circuit and ensure that the switching means comprised in the inverter are no longer rendered conductive and non-conductive. Alternatively the circuit part III could switch off the supply voltage source.

Good results have been obtained for a circuit arrangement according to the invention, wherein the circuit part I comprises a voltage divider equipped with a first impedance and a second impedance and wherein the test circuit comprises a series arrangement shunting the second impedance and comprising a switching element and a third impedance. During normal operation the start circuit controls the switching element in a conductive state. The second impedance and the third impedance are in parallel and together represent an impedance that has a (much) lower impedance value than the impedance value of the second impedance. During the first operating state, however, the start circuit ensures that the switching element is maintained in a non-conductive state. As a consequence the third impedance is not in parallel with the second impedance so that the impedance value of the second impedance is not decreased. Therefore the voltage that is present over the second impedance is a bigger fraction of the voltage present over the voltage divider during the first operating state than during normal operation. In case the lamp voltage is present across the voltage divider, the fraction of the lamp voltage that is present over the second impedance during the first operating state is (much) higher than during normal operation. By deriving the first signal from the voltage over the second impedance, it is thus realized that the first signal is comparatively high during the first operating state despite the comparatively low amplitude of the lamp voltage. For a proper functioning, the voltage divider needs to be either resistive or capacitive. To avoid power dissipation it is preferred that the voltage divider is capacitive and the third impedance comprises a capacitance.

Alternatively, the circuit part II may comprise a voltage divider equipped with a first impedance and a second impedance and the test circuit may comprise a series arrangement shunting the second impedance and comprising a switching element and third impedance. During the first operating state the start circuit controls the switching element in a conductive state. The second impedance and the third impedance are in parallel and together represent an impedance that has a (much) lower impedance value than the impedance value of the second impedance. During normal operation, however, the start circuit ensures that the switching element is maintained in a non-conductive state. As a consequence the third impedance is not in parallel with the second impedance so that the impedance value of the second impedance is not decreased. Therefore the voltage that is present over the second impedance is a smaller fraction of the voltage present over the voltage divider during the first operating state than during normal operation. When a constant DC voltage is present across the voltage divider and the voltage over the second impedance is chosen as the second signal, the second signal is lower during the first operating state than during normal operation. Thus it is realized that the first signal is bigger than the second signal during the first operating state in spite of the comparatively low lamp voltage and the resulting low value of the first signal.

Preferably a circuit arrangement according to the invention comprises a circuit part IV coupled to the circuit part III for determining whether the lamp has ignited. Under unusual conditions, the discharge lamp may ignite under the influence of the comparatively low voltage across it during the first operating state. In case this happens the voltage over the discharge lamp will drop dramatically, so that the first signal will be smaller than the second signal and the voltage at the output of the comparator comprised in the lamp voltage measuring circuit will not change, although the lamp voltage measuring circuit is functioning correctly. It is undesirable that the circuit arrangement is rendered inoperative in this situation by means of circuit part II. In case, however, the circuit part IV determines that the lamp has ignited, circuit part III does not render the circuit arrangement inoperative, even when the voltage at the output terminal of the comparator does not change during the first operating state.

An embodiment of a circuit arrangement according to the invention will be explained making reference to a drawing.

In the drawing,

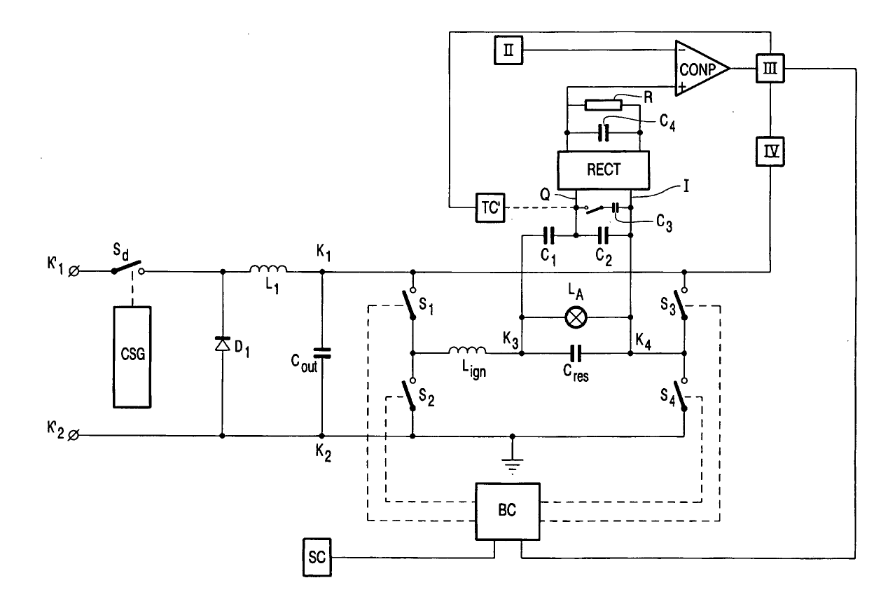

FIG. 1 shows an embodiment of a circuit arrangement according to the invention with a discharge lamp LA connected to it.

In FIG. 1, K1′ and K2′ are terminals for connection to a voltage source. Input terminals K1′ and K2′ are connected by means of a series arrangement of a switching element Sd, an inductive element L1 and an output capacitor Cout. Terminal K2′ is connected to a common terminal of switching element Sd and inductive element L1 by means of a diode D1. CSG is a circuit part for generating a control signal for alternately rendering switching element Sd conductive and non-conductive. An output terminal of circuit part CSG is coupled to a control electrode of switching element Sd. Switching element Sd, circuit part CSG, inductive element L1, diode D1 and output capacitor Cout together form a DC-DC-converter of the type down converter. A common terminal of inductive element L1 and output capacitor Cout is connected to an input terminal K1. Terminal K2′ is connected to an input terminal K2. Input terminals K1 and K2 are connected by a series arrangement of switching elements S1 and S2 and by a series arrangement of switching elements S3 and S4. Circuit part BC is a control circuit for controlling the conductive state of switching elements S1-S4. Respective output terminals of circuit part BC are therefor coupled to respective control electrodes of switching elements S1, S2, S3 and S4. Circuit part BC together with the switching elements S1-S4 together form an inverter for generating a high frequency voltage out of the supply voltage supplied by the supply voltage source formed by the voltage source that terminals K1′ and K2′ are connected to, together with the down converter. Switching elements S1-S4 together form switching means comprised in the inverter. A first input terminal of control circuit BC is connected to an output terminal of circuit part SC. Circuit part SC is a start circuit for maintaining the circuit arrangement in a first operating stage in which the actual lamp voltage is smaller than the desired value. A common terminal of switching elements S1 and S2 forms a first output terminal of the inverter. A common terminal of switching elements S3 and S4 forms a second output terminal of the inverter. The first output terminal of the inverter is connected to the second output terminal by means of a load circuit comprising a series arrangement of an inductive element Lign, lamp connection terminal K3, a capacitive element Cres and lamp connection terminal K4. A discharge lamp LA of the type UHP (Ultra High Pressure) is connected to the lamp connection terminals.

The lamp is shunted by a series arrangement of a capacitor C1 and a capacitor C2. This series arrangement forms a capacitive voltage divider. Capacitor C2 is shunted by a series arrangement of capacitor C3 and switching element Q. A control electrode of switching element Q is coupled to an output terminal of circuit part TC′. Circuit part TC is a circuit part for controlling the conductive state of switching element Q. Respective sides of capacitor C2 are connected to respective input terminals of circuit part RECT comprising a rectifier such as a diode bridge. A capacitor C4 connects the output terminals of circuit part RECT. Capacitor C4 is shunted by ohmic resistor R.

Capacitors C1, C2 and C4, circuit part RECT and ohmic resistor R together form a circuit part I for generating a first signal that represents the voltage across the discharge lamp. A first end of resistor R is connected to a first input terminal of a comparator COMP. A second input terminal of comparator COMP is connected to an output terminal of circuit part II. Circuit part II forms a circuit part for generating a second signal representing a desired value of the lamp voltage. Circuit part TC′ switching element Q and capacitor C3 together form a test circuit for making the first signal larger than the second signal during the first operating state. Circuit part I, circuit part II, comparator COMP and the test circuit together form a lamp voltage measuring circuit. An output terminal of comparator COMP is connected to a first input terminal of circuit part III. Circuit part III is a circuit part for changing the operating state of the circuit arrangement. A second input terminal of circuit part III is connected to an output terminal of circuit part IV. Circuit part IV is a circuit part for determining whether the lamp has ignited. An input terminal of circuit part IV is connected to input terminal K1. A first output terminal of circuit part III is connected to a second input terminal of control circuit BC and a second output terminal of circuit part III is connected to an input terminal of circuit part TC′.

It be mentioned that many of the circuit parts explicitly denominated in the description and in FIG. 1 may be realized making use of a microprocessor and software.

The operation of the circuit arrangement shown in FIG. 1 is as follows.

When terminals K1′ and K2′ are connected to a voltage source, circuit part CSG renders the switching element Sd conductive and non-conductive at a high frequency. As a result a DC voltage with an amplitude that is lower than that of the voltage supplied by the voltage source is present between the input terminals K1 and K2. This DC voltage serves as a supply voltage for the inverter. Immediately after the circuit arrangement has been activated, the circuit part SC ensures that the circuit arrangement is maintained in a first operative state. In this first operative state the circuit part BC renders the switching elements S1 and S4 and the switching elements S2 and S3 alternately conductive at a comparatively high frequency. Switching elements S2 and S3 are non-conductive when switching elements S1 and S4 are conductive and vice-versa. Because of the comparatively high frequency at which the switching elements are controlled, the lamp voltage is comparatively small, so that damage to the lamp LA and damage to the circuit arrangement are avoided in the first operating state. During the first operating state the circuit part TC′ controls the switching element Q in a non-conductive state. As a consequence, a comparatively large part of the lamp voltage that is present over the series arrangement of capacitors C1 and C2 is present across capacitor C2 and between the input terminals of the circuit part CRECT. The circuit part CRECT rectifies the AC voltage that is present across capacitor C2. The rectified voltage is smoothed by capacitor C4 and resistor R and is present at the first input terminal of comparator COMP. This voltage present at the first input terminal of comparator COMP is the first signal representing the lamp voltage. Due to the test circuit formed by circuit part TC′, switching element Q and capacitor C3, the value of the first signal increases to a comparatively high value shortly after the activation of the circuit arrangement. The value of the first signal will therefore, in spite of the low lamp voltage, increase to a value higher than the second signal generated by circuit part II and present at the second input terminal of the comparator COMP. Several situations can be discriminated.

In the first situation the lamp has not ignited and the lamp voltage measuring circuit is functioning correctly. In this first situation the voltage at the output terminal of comparator COMP changes from low to high and the voltage over output capacitor Cout does not show a sudden decrease in value caused by the very high current through the lamp directly after ignition. The circuit part III ensures that the first operating state is ended. The switching element Q is rendered conductive and the circuit part BC subsequently controls the switching elements S1-S4 in such a way that an ignition voltage is generated across the lamp. This ignition voltage is controlled at a level that is safe and does not damage the lamp or the circuit arrangement by means of the lamp voltage measuring circuit. When the lamp has ignited the circuit part BC controls the switching elements S1-S4 in a way that corresponds to subsequent operating stages of the lamp. In case of a high pressure discharge lamp these are “take-over” and stationary operation. In this connection the wording “take-over” is used to indicate the lamp behaviour and corresponding operation of the lamp immediately after the lamp has ignited. During stationary operation the DC-DC-converter is operated as a current source and the inverter as a commutator for commutating the current through the lamp at a low frequency (for instance 60 Hz).

In the second situation the lamp has ignited and the lamp voltage measuring circuit is functioning either correctly or not correctly. In this second situation the voltage at the output terminal of comparator COMP does not change from low to high since the voltage across the lamp immediately after ignition is very low. However, the voltage over output capacitor Cout shows a sudden decrease in value caused by the very high current through the lamp directly after ignition. This sudden decrease causes the voltage at the output terminal of circuit part IV to change from low to high. As a result the circuit part III ensures that the first operating state is ended. The switching element Q is rendered conductive and, in case the lamp is a high pressure discharge lamp, the circuit part BC subsequently controls the switching elements S1-S4 in such a way as corresponds to “take-over” and stationary operation of the lamp.

In the third situation the lamp has not ignited and the lamp voltage measuring circuit is not functioning correctly. In this third situation the voltage at the output terminal of comparator COMP does not change from low to high and the voltage over output capacitor Cout does not show a sudden decrease in value caused by the very high current through the lamp directly after ignition. The circuit part III ensures that the first operating state is ended and that the circuit part BC subsequently no longer controls the switching elements S1-S4 so that the inverter is effectively switched off.

It be mentioned that the invention is also suitable to be implemented in embodiments wherein the inverter is a halfbridge circuit and in embodiments wherein the inverter is supplied by a voltage source and the switching elements of the inverter are controlled in a “commutating forward mode” during stationary operation. In the “commutating forward mode”, for each direction of the lamp current, one of the switching elements of the inverter is operated at a high frequency (for instance 35 kHz) and together with the inductive element in the load circuit and a diode (for instance the body diode of another switching element implemented as a FET) forms a down converter. Also in this type of embodiment, the direction of the lamp current is reversed at a low frequency. For each direction of the current a different switching element of the inverter is operated at a high frequency. In this type of embodiment the current through the lamp can be controlled by means of the switching element that is operated at a high frequency.

1. Circuit arrangement for igniting and operating a discharge lamp, equipped with
input terminals for connection to a supply voltage source,
an inverter coupled to the input terminals for generating a high frequency voltage out the supply voltage, and equipped with switching means and a control circuit for controlling the conductive state of the switching means,
a load circuit coupled between output terminals of the inverter and comprising lamp connection terminals arranged in series with an inductive element and shunted by a capacitive element,
a lamp voltage measuring circuit comprising
a circuit part I for generating a first signal that represents the voltage across the discharge lamp,
a circuit part II for generating a second signal representing a desired value of the lamp voltage,
a comparator equipped with a first input terminal coupled to an output terminal of circuit part I, and with a second input terminal coupled to an output terminal of circuit part II,
a circuit part III for changing the operating state of the circuit arrangement and coupled to an output terminal of the comparator,
characterized in that the circuit arrangement is further equipped with
a start circuit coupled to the control circuit for maintaining the circuit arrangement in a first operating state in which the actual lamp voltage is smaller than the desired value,
a test circuit, comprised in the lamp voltage measuring circuit, for making the first signal larger than the second signal during the first operating state.

2. Circuit arrangement according to claim 1, wherein the circuit part I comprises a voltage divider equipped with a first impedance and a second impedance and wherein the test circuit comprises a series arrangement shunting the second impedance and comprising a switching element and a third impedance.

3. Circuit arrangement as claimed in claim 3, wherein the voltage divider is capacitive and the third impedance comprises a capacitance

4. Circuit arrangement according to claim 1, wherein the circuit part II comprises a voltage divider equipped with a first impedance and a second impedance and wherein the test circuit comprises a series arrangement shunting the second impedance and comprising a switching element and a third impedance.

5. Circuit arrangement according to claim 1, wherein the circuit arrangement further comprises a circuit part IV coupled to the circuit part III for determining whether the lamp has ignited.

6. Projection equipment comprising a high pressure discharge lamp and a circuit arrangement according to claim 1.
